(19) United States
(12) Patent Application Publication
(10) Pub. No.: US 2015/0161659 A1
(43) Pub. Date: Jun. 11, 2015

(54) SYSTEMS AND METHODS FOR ASSESSING THE CROSS-CHANNEL VALUE OF MEDIA ADVERTISING

(71) Applicant: OptiMine Software, Inc., Minneapolis, MN (US)

(72) Inventor: Robert W. Cooley, St. Paul, MN (US)

(21) Appl. No.: 14/560,994

(22) Filed: Dec. 4, 2014

Related U.S. Application Data
(60) Provisional application No. 61/912,310, filed on Dec. 5, 2013.

(51) Int. Cl. G06Q 30/02

(52) U.S. Cl. CPC G06Q 30/0246; G06Q 30/0264

(57) ABSTRACT

Systems and methods for assessing the cross-channel value of advertising. One computer-implemented method includes receiving, at a processor, a number of impressions for a particular advertisement for a specified time period. A next step includes selecting an entry point for a business event related to the particular advertisement, and receiving business value information from the entry point for the specified time period. A relationship between the particular advertisement and the entry point for the business event is analyzed based on the number of impressions for the particular advertisement and the business value from the entry point for the specified time period.

### RELATED APPLICATIONS

This application claims priority benefit to U.S. Provisional Application No. 61/912,310 filed Dec. 5, 2013, the entire contents of which are hereby incorporated by reference.

### FIELD

Embodiments of the invention relate to systems and methods for assessing the cross-channel value of advertising. In particular, embodiments of the invention determine a value for an advertisement based on a volume of impressions for that advertisement and corresponding revenue.

### BACKGROUND

The purchasing of advertising, also known as media buying, is useful for many forms or channels of advertising, such as Internet paid search advertising, Internet display advertising, television advertising, radio advertising, newspaper advertising, mobile device advertising, magazine advertising, and outdoor advertising. It is also valuable to an advertiser to be able to assess a financial return on (or performance of) an advertising investment, such as to determine the value of the advertising (i.e., how much should be invested in that particular advertisement). Based on the performance of an advertisement or ad campaign (herein collectively referred to as an “ad” or an “advertisement”), an advertiser can make more informed decisions regarding which ads to invest in and how much to invest.

### SUMMARY

Therefore, embodiments of the invention provide systems and methods for assessing the value of cross-channel advertising. For example, the invention provides a computer-implemented method for assessing the value of cross-channel advertising. The method includes receiving, at a processor, an advertisement and an individual entry point (e.g. search keyword) that is potentially influenced by the advertisement. The method further includes determining by mathematical modeling whether the advertisement influences the entry point, and to what magnitude, based on impression data and revenue related to the advertisement over a certain period of time. The method also includes calculating a magnitude to which the advertisement affects the entry point as a value per impression.

One system includes memory, a processor, a non-transitory computer-readable medium, and an input/output interface. The computer-readable medium stores in memory and encodes instructions executable by the processor to analyze a relationship between the impressions served of a particular advertisement and the value received for a product or service relating to the advertisement and calculate a value per impression (“VPI”) of the advertisement. The VPI is determined based on information regarding impressions related to the advertisement and revenue. The revenue and impressions information can be accessed from one or more data sources (e.g., a web server) via the input/output interface. The memory includes a number of impression for a particular advertisement for a specified time period, entry points for a business event related to the particular advertisement, business value information from the entry point for the specified time period, and an advertisement-to-entry-point relationship model that determines whether the particular advertisement influences the entry point for the business event. The processor is configured to select an entry point for a business event related to the particular advertisement, and determine, via the advertisement-to-entry-point relationship model, whether the particular advertisement influences the entry point for the business event based on the number of impressions for the particular advertisement and the business value from the entry point for the specified time period.

In another embodiment, a non-transitory computer-readable medium is encoded with a plurality of processor-executable instructions. The instructions include receiving, at a processor, a number of impressions for a particular advertisement for a specified time period. A next instruction is selecting an entry point for a business event related to the particular advertisement. Another instruction is receiving business value information from the entry point for the specified time period. Then, an instruction provide for determining, by mathematical modeling, whether the particular advertisement influences the entry point for the business event based on the number of impressions for the particular advertisement and the business value from the entry point for the specified time period.

Other aspects of the invention will become apparent by consideration of the detailed description and accompanying drawings.

### BRIEF DESCRIPTION OF THE DRAWINGS

FIG. 1 illustrates methodology performed by an attribution-based system.

FIG. 2 schematically illustrates an advertisement appraisal system.

FIG. 3 illustrates methodology performed by the advertisement appraisal system of FIG. 2.

FIG. 4 illustrates a web browser for searching keywords or combinations of keywords in a search channel.

FIG. 5 is a flowchart illustrating a method for determining the cross-channel value of an advertisement in an exemplary embodiment of the system in FIG. 2.

FIG. 6 illustrates a formula for determining the value of an advertisement according to one embodiment of the invention.

FIG. 7 illustrates advertisement-to-entry-point relationships.

FIG. 8 illustrates compensating for known variances in daily orders to generate a remaining unexplained variance.

FIG. 9 illustrates a daily number of impressions of an advertisement candidate with poor correlation to a remaining variance.

FIG. 10 illustrates a daily number of impressions of an advertisement candidate with good correlation to a remaining variance.

FIG. 11 illustrates a flowchart of an exemplary process for assessing a cross-channel value of media advertising.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (e.g., stored on non-transitory computer-readable medium). As such, it should be noted that a plurality of hardware and software based devices, as well as a plurality of different structural components may be utilized to implement embodiments of the invention.

It should be noted that a plurality of hardware and software based devices, as well as a plurality of different structural components may be utilized to implement the invention. Furthermore, and as described in subsequent paragraphs, the specific configurations illustrated in the drawings are intended to exemplify embodiments of the invention and that other alternative configurations are possible.

Further, while the examples discussed herein refer mainly to display and search advertising channels, the concepts derived from these examples can be applied to other advertising channels, and are therefore are not limited strictly to the particular channels described herein.

In the context of advertising, “business events” are actions considered to be of value to an advertiser, such as conversions, orders or sales, leads, or applications or registrations. Business events can be assigned a “business value,” such as revenue, margin, or profit. More business events arising from a particular advertisement generally result in an increased return on the advertisement investment, thus rendering a more valuable investment. The number of times an advertisement is displayed is referred to as an “impression.” Following an impression, various events can occur. For example, if a user views a displayed advertisement, the event is referred to as a “view.” Within the context of Internet-based advertising, if a hypertext link associated with an advertisement is selected by an individual, the event is referred to as a “click-through” or simply a “click.” The click-through leads a user to an advertiser's web site or page, presumably where goods or services are offered, which may potentially lead to a business event. Therefore, advertisement impressions can lead to clicks, which can lead to business events, which have a business value (that can be represented as business value information).

Advertisers typically use a mix of channels to achieve their marketing objectives, just as consumers use a mix of channels to research a potential purchase and eventually make the purchase. The channel through which a consumer eventually makes a purchase is herein referred to as the “buying channel.” This cross-channel approach to advertising and purchasing makes measuring the value of a particular advertisement more complex due to the difficulties of tracking impressions across different channels. For example, although it can be easy to quantify the value of an advertisement that led to a purchase within a single channel, it is difficult to quantify the value of ads viewed in an additional channel that might have also led to the purchase. This is because it is often unknown to what extent the advertisement viewed in the additional channel impacted the purchase or even the views in the single channel. For example, when consumers turn to channels such as search channels (e.g., Internet keyword searches), they do so with the intent of looking for something specific (such as product information, where to buy a product, etc.). These consumers are closer to making a buying decision within the search channel, and, therefore, it is natural that the search channel would receive higher rates of clicks and conversions based on this direct, in-channel manner of shopping. Since the clicks and conversions presumably occur entirely within the search channel, tracking the path that led to the eventual purchase of the item is relatively straight forward as is measuring the value of the advertisement that led to the purchase within that channel. However, ads outside of the search channel may have had an impact on the purchase. In this case, it is difficult to attribute value to those ads occurring outside the search channel that also led to the purchase.

Channels such as display advertising channels are subject to mass viewing and yet are not often used as portals to making clicks and direct purchases (i.e., are not often used as buying channels). This is because the consumers viewing the ads do not visit the websites hosting the advertisement with the intention of buying. Oftentimes a consumer will view a display advertisement without clicking it, only to later conduct an Internet search (a different channel from the one in which the display advertisement was viewed) related to the display advertisement, which will eventually lead to a purchase. For example, consumers are often bombarded with advertisements within a social network environment, but may never click on any of the advertisements. However, the consumer may later conduct a keyword search using a search engine based on information contained in the advertisements presented in the social networking environment (e.g., product name, company name, etc.). Therefore, although the ultimate purchase is made via the search channel, the view of an advertisement in a different channel can be integral to the eventual purchase by “introducing” the consumer to the search channel. Therefore, the display of the advertisement should not be disregarded when attributing value to the advertisement along the path that led to the purchase.

However, since purchase paths can be split across multiple channels, it is difficult to assess the cross-channel effect of an advertisement on a purchase or on a number of purchases over time. In particular, it is difficult to understand and measure the impact that one channel, such as the display channel, has on revenue earned through another channel, such as the search channel. In particular, obstacles to assessing the cross-channel value of advertising arise from (1) the fragmentation of purchase paths across multiple channels, (2) the level or “granularity” at which each advertisement's impact is to be assessed (i.e., on a per advertisement basis, on a basis of a grouping of advertisements, etc.), and (3) the ability to isolate different purchase-influencing factors such as seasonality and competition from the assessment of an advertisement's value to determine the incremental (uninfluenced) impact of that advertisement in generating a certain revenue.

Firstly, with regard to the fragmentation of paths across different channels, the use of multiple devices and multiple browsers (as well as multiple individuals using the same device) leads to broken or corrupt data that cannot be used to reconstruct a complete and reliable advertising path leading to a particular business event by an individual. For example, third-party cookies can be used to track devices that have viewed an advertisement. However, since cookies are device-specific, if an individual views an advertisement on a work computer but makes a purchase related to the advertisement on a home computer, the cookies do not properly identify that the same individual who viewed a particular advertisement also made the later purchase. Furthermore, if an individual views an advertisement on a work computer, a mobile device, and a home computer, there is no way to know the same individual is actual viewing the advertisement on all three devices. Therefore, although the advertisement is attributed three views due to three different devices viewing the advertisement, only a single view can truly be attributed to the advertisement, since only a single individual using the three devices viewed the advertisement and had the potential to generate a business event based on that advertisement.

Secondly, with regard to granularity, the individual influences of an advertisement in one channel (e.g., the display channel) on advertisements and eventual business events in another channel (e.g., the search channel), must be assessed at the level of an individual entry point (i.e., an individual-advertisement and individual-entry point level). An entry point is any method by which an individual can access a business location, such as an advertiser's website. For example, an entry point can include accessing a website through the results of a keyword search (e.g., a regular Internet search or a paid Internet search), by directly typing the website's address (i.e., a uniform resource locator (“URL”)), by clicking on a link in another website (e.g., an affiliated website), etc. At the individual entry point level, a number of views of a specific advertisement can be correlated directly with a certain number of business events arising from that advertisement. This allows a particular advertisement driving a certain cross-channel purchasing behavior to be identified, which is useful in assessing the performance and value of that advertisement.

Thirdly, with regard to determining the incremental impact an advertisement has on generated revenue, factoring out other influences such as seasonality and competition, which may have also influenced revenue, helps determine how much the display of a particular advertisement alone contributed to revenue over a certain period of time.

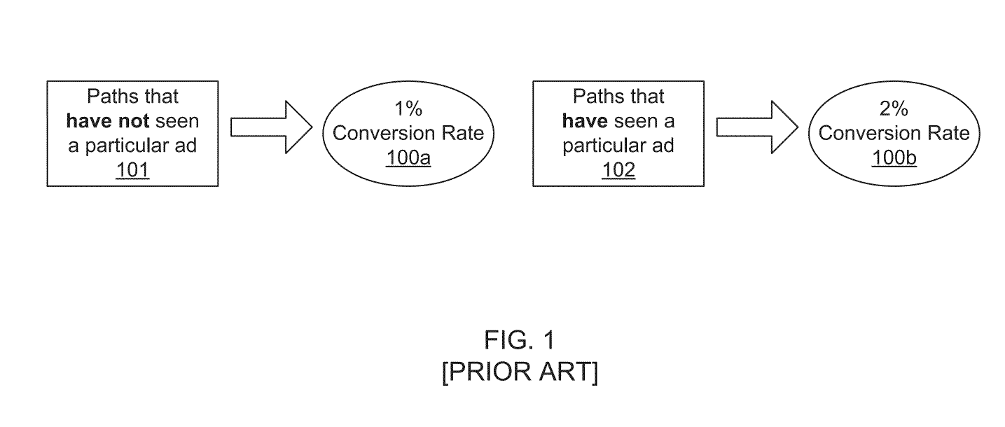

The issues of achieving entry point level granularity and determining the incremental impact of an advertisement on revenue are overcome by the appropriate mathematical models, such as those that can be implemented according to embodiments of the invention. The issue of fragmentation, however, can be handled in various ways. Existing systems and methods addressing the issue of fragmentation are predominantly attribution-based implementations. For example, FIG. 1 illustrates methodology applied by an attribution-based system. Attribution-based systems track the paths of individuals as they interact with advertisements and websites over time. In particular, attribution-based systems compare a number of business events 100a (e.g., a number or rate of conversion) for purchase paths that have not seen a particular advertisement 101 with a number of business events 100b (e.g., a number or rate of conversion) for purchase paths that have seen the advertisement 102. In other words, attribution-based systems require the ability to separate purchase paths into groups that have or have not seen a particular advertisement. Based on the purchase paths have included a particular advertisement and whether that encountered advertisement caused the path to end in a business event, value is attributed to the particular advertisement. For example, when a tracked individual generates a business event, such as by making a purchase, the attribution system allocates the value of the event among all the ads the individual encountered along the tracked purchase path.

Most attribution systems rely on technologies such as third-party cookies to track specific instances of a Web browser that have been interacting with websites over time, and thus which advertisements a browser has seen or clicked. However, as described above, since these technologies are attached to a specific instance of a browser on a specific device, and not the individual using the browser or device, the use of multiple devices or browsers by a single individual to generate a business event leads to incomplete paths. In other words, the purchase path cannot be tracked to completion since the path cannot be tracked across devices. Similarly, multiple people using the same browser will corrupt a purchase path. For example, if a child on a parent's computer generates a purchase path by viewing or clicking certain ads, the advertisements viewed by the child will be incorrectly placed in the purchase path of the parent. This results in the tracking of advertisement views or clicks along the path of the parent (since the clicks and views of the child occurred on the parent's device), which are inconsistent with the remainder of the views and clicks in that path. Therefore, value is misattributed to advertisements that the child clicked but that did not contribute to the parent's eventual purchase.

Some attribution-based systems, however, do not use third-party cookies to track the path of an individual to determine which advertisements included a business event by a particular individual. Instead, these systems attempt to identify advertisements that led to a business event by drawing upon an individual's personal and/or purchase information to determine which advertisements the individual likely viewed. Value is then attributed to those potentially-viewed advertisements. For example, based on the individual's purchase information (e.g., the individual's demographics, the time the purchase was made, the payment method of the purchase, etc.), a set of advertisement that the individual may have seen can be identified (e.g., advertisements presented within a predetermined time from the purchase time in the individual's geographic location and targeted to the individual's demographic). This process is repeated for every purchase and every individual who makes a purchase. However, this attribution-based system still attempts to characterize “who” (i.e., which path) has seen a particular advertisement in order to attribute value to that advertisement. Also, this approach can raise privacy concerns because it requires personal information from each purchaser.

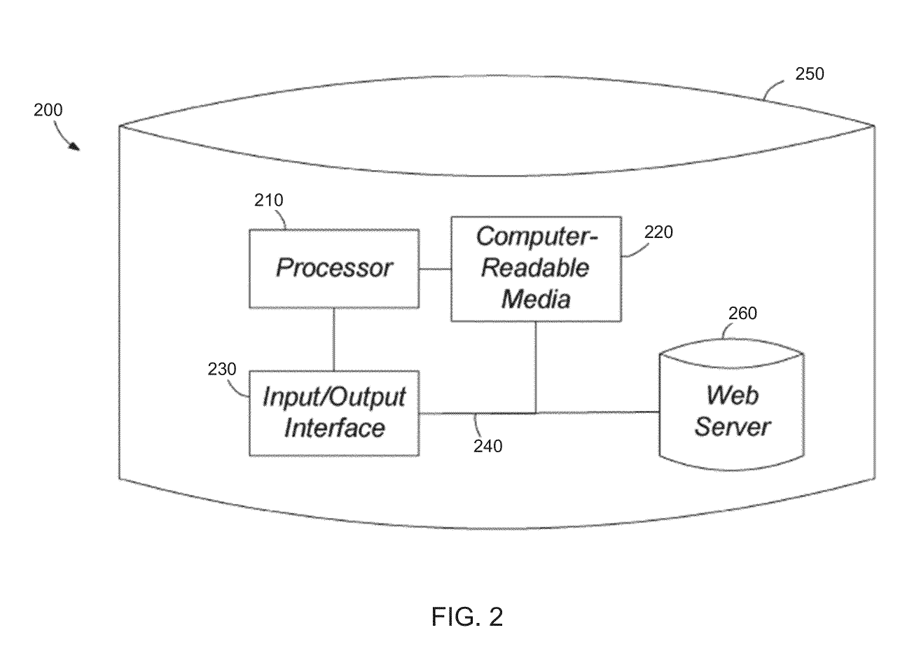

Therefore, to overcome these and other problems, embodiments of the invention relate to an audience-based system, which follows a number of advertisement impressions over time and a number of business events generated through individual entry points during that time. For example, FIG. 2 illustrates an audience-based advertisement appraisal system 200 according to one embodiment of the invention. As shown in FIG. 2, the system 200 includes a processor 210, computer-readable media 220, and an input/output interface 230. The processor 210, computer readable media 220, and input/output interface 230 are connected by one or more connections 240, such as a system bus. It should be understood that although the processor 210, computer-readable media 220, and input/output interface 230 are illustrated as part of a single server or other computing device 250, components of the system 200 can be distributed over multiple servers or computing devices. Similarly, the system can include multiple processors 210, computer-readable media 220, and input/output interfaces 230.

The processor 210 retrieves and executes instructions stored in the computer-readable media 220. The processor 210 can also store data to the computer-readable media 220. The computer-readable media 220 can include non-transitory computer readable medium and can include volatile memory, non-volatile memory, or a combination thereof. In some embodiments, the computer-readable media 220 includes a disk drive or other types of large capacity storage mechanism. The computer-readable media 220 can also include a database structure that stores data processed by the system 200 or otherwise obtained by the system 200.

The input/output interface 230 receives information from outside the system 200 and outputs information outside the system 200. For example, the input/output interface 230 can include a network interface, such as an Ethernet card or a wireless network card, which allows the system 200 to send and receive information over a network, such as a local area network or the Internet. In some embodiments, the input/output interface 230 includes drivers configured to receive and send data to and from various input and/or output devices, such as a keyboard, a mouse, a printer, a monitor, and similar devices.

As shown in FIG. 2, the system 200 can also include one or more data sources, such as a web server 260. The web server 260 can include a processor and computer-readable media and can provide impression data. The web server 260 can also host one or more websites accessible through a browser application, such as Internet Explorer®, Firefox®, Chrome®, etc.

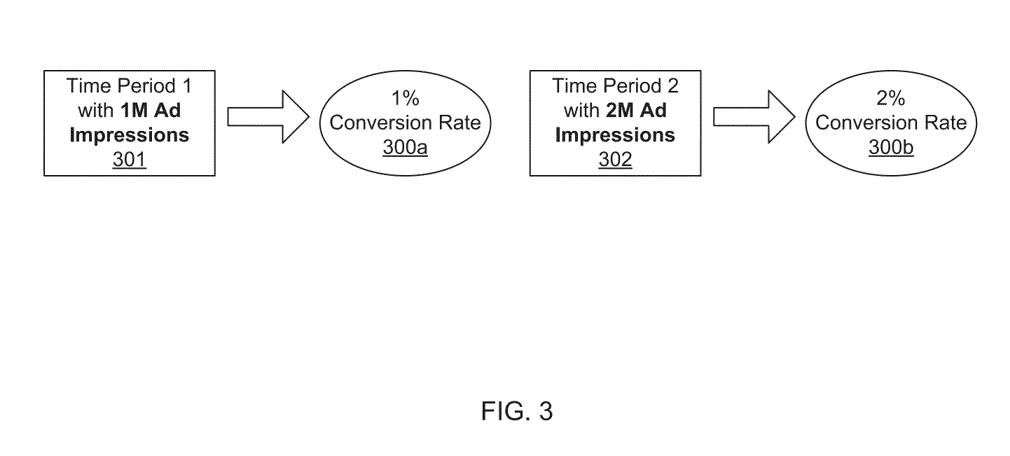

FIG. 3 illustrates how the system 200 identifies the cross-channel value of an advertisement over time. For example, the system 200 correlates a volume of impressions for a particular advertisement during a certain or specified time period with an amount of revenue generated within the same time period. In particular, as illustrated in the example provided in FIG. 3, a 1% conversion rate 300a is correlated with a time period 301, which has one million impressions of a particular advertisement. Similarly, a 2% conversion rate 300b is correlated with a time period 302, having two million impressions for the same advertisement. With this change in impression volume between the time period 301 and the time period 302, as well as the change in revenue generated between the time periods 301 and 302, the system 200 can determine a value for the advertisement (i.e., how much revenue each advertisement impression is responsible for).

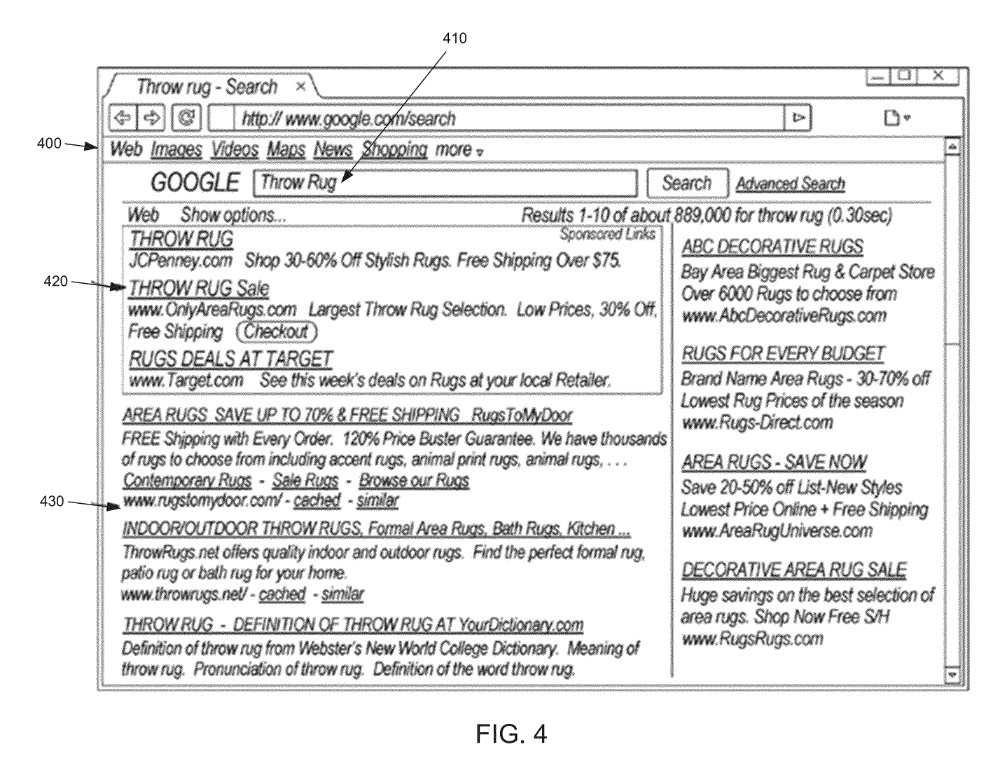

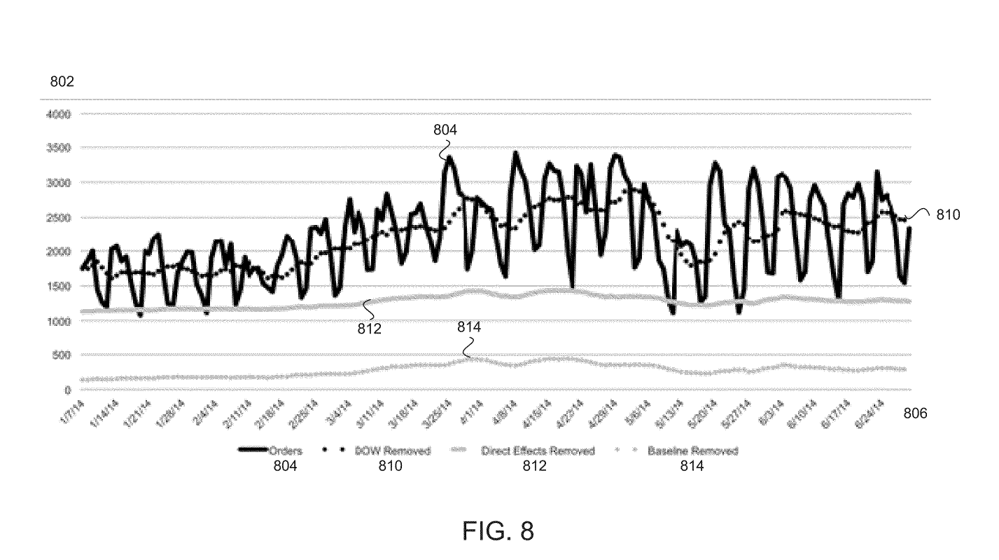

Therefore, the system 200 does not track who (i.e., which paths) have seen an advertisement, but instead determines the incremental value of an advertisement based on how many individuals have seen the advertisement (i.e., how many impressions the advertisement receives). In an exemplary embodiment, the system 200 is configured to determine how display advertising affects paid search performance by identifying causal relationships between display advertisement impressions and the performance of certain entry points, such as search keywords (shown in greater detail below in relation to FIGS. 8-10). For example, FIG. 4 illustrates a web browser 400 used by an individual to search a keyword 410. It should be understood that as used in the present application, the term “keyword” includes both single words and combinations of words (e.g., key phrase). Based on the keyword 410, the web browser 400 displays paid search results 420 and unpaid search results 430 that are relevant to the keywords 410. For the purpose of this example, the paid search results 420 comprise advertisements in a buying channel (which, in this case, is the paid search channel) and display advertisements (such as those displayed on websites other than a search engine) comprise a branding channel.

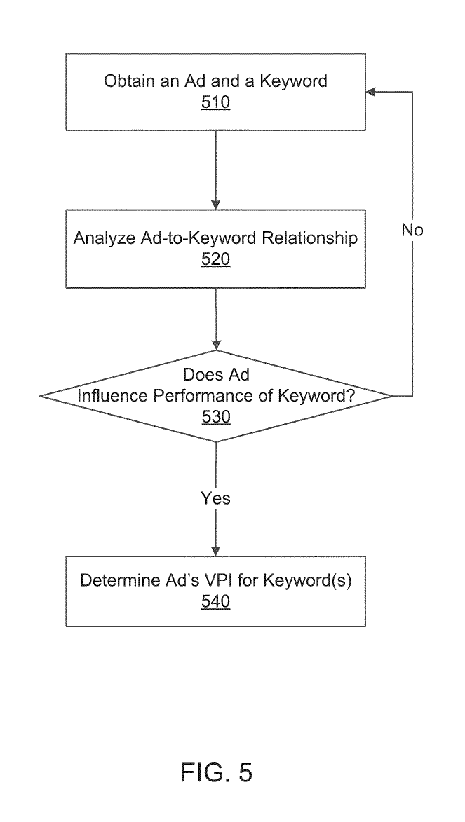

FIG. 5 illustrates the method for determining the cross-channel value of an advertisement as implemented in this exemplary embodiment. The computer-readable media 220 can contain instructions that, when executed by the processor 210, perform the method illustrated in FIG. 5. For example, the system 200 receives a particular display advertisement and an entry point (e.g., a keyword) that is potentially influenced by that advertisement (at block 510). The advertisement and keyword can be received by the system 200 from either a user or the web server 260 via the input/output interface 230. The keyword can be selected for analysis, for example, due its explicit use in the advertisement (textual feature of the advertisement) or its implicit use (such as by a description of a non-textual feature of the advertisement or a synonym of a term used in the advertisement). The processor 210 analyzes a purchase-driven relationship between the particular advertisement and keyword (at block 520). This logic, for example, can comprise a mathematical model or other analytical method that can determine the extent to which the particular advertisement affects the purchase-driven performance (such as a number of searches leading to a business event) of the specific keyword. For example, a time series model, such as an econometric time series forecast model, can be used to determine relationships between advertisements and entry points. In some embodiments, the logic or models stored in the computer-readable medium 220 and used by the processor 210 return a “positive” or “negative” value indicating whether a performance-influencing relationship exists between a particular advertisement and a particular entry point (e.g., keyword) (e.g., based on whether predetermined conditions are met). A positive value indicates that performance-influencing relationship exists between the particular advertisement and the particular entry point and the magnitude of the relationship. A zero or negative value indicates that performance-influencing relationship does not exists between the particular advertisement and the particular entry point or that a negative performance-influencing relationship exists between the particular advertisement and the particular entry point. It should be understood that the system 200 can receive additional data in analyzing the advertisement-to-entry-point relationship (e.g., from a user, the web server 260, or another data source).

Econometrics is the application of mathematics, statistical methods, and computer science, to economic data and is described as the branch of economics that aims to give empirical content (based on observation or experimentation) to economic relations. More precisely, econometrics is “the quantitative analysis of actual economic phenomena based on the concurrent development of theory and observation, related by appropriate methods of inference.” Econometrics is used to extract simple relationships from a large quantity of data. Econometrics often uses linear regression modeling to extract these relationships.

A time series is a sequence of data points, measured typically at successive points in time spaced at uniform time intervals. Time series analysis comprises methods for analyzing time series data in order to extract meaningful statistics and other characteristics of the data. Time series forecasting is the use of a model to predict future values based on previously observed values.

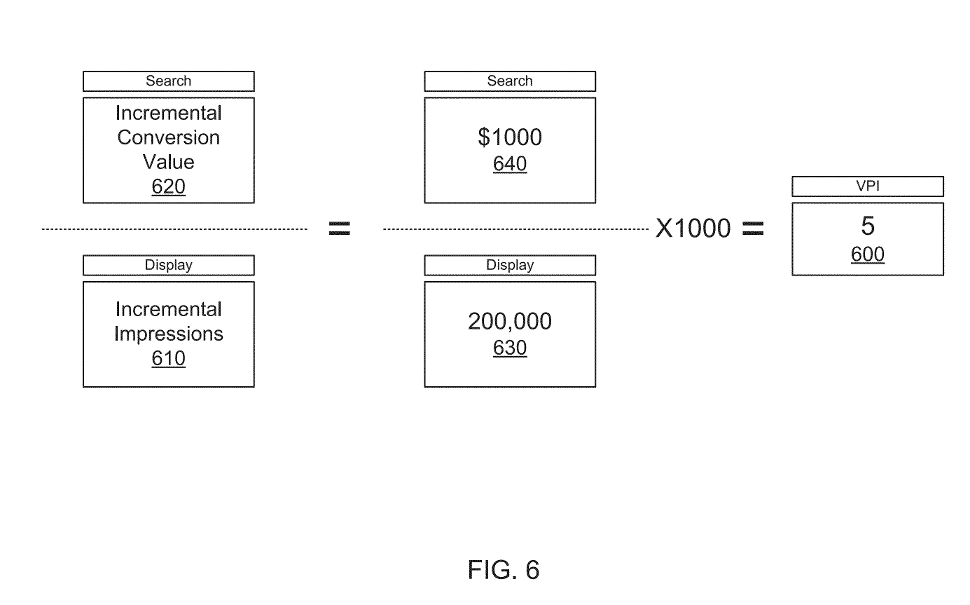

If the processor 210 determines that the advertisement does not influence the performance of the keyword (at block 530), the system 200 returns to block 510 and receives another keyword to be analyzed for the advertisement. However, if the processor 210 determines that the advertisement does influence the performance of the keyword (at block 530), the system 200 determines to what magnitude the advertisement affects the keyword performance (at block 540). This is done by calculating the incremental value of the advertisement or the incremental amount that each advertisement impression contributes to the revenue generated by the advertisement during a certain time period. For example, FIG. 6 illustrates a formula for determining the incremental value of an advertisement according to one embodiment of the invention. As illustrated in FIG. 6, the system 200 determines the value of an advertisement as a Value per Impression (“VPI”). In some embodiments, the system 200 determines a value on groups of impressions, such as a value per thousand Impressions. When calculating the VPI for a particular advertisement-to-entry-point relationship, the system 200 receives readily-available impression data (e.g., from the webserver 260). The impression data can include a volume of impressions that the advertisement received during a certain period of time. The system 200 also receives revenue information for products or services related to the advertisement for the same period of time (e.g., for the entire company, for an entire product line, for a specific product, etc.). In some embodiments, the system 200 communicates with a company accounting or similar system for obtaining the revenue data.

The processor 210 uses the impression data and the revenue data to calculate a VPI for the advertisement. For example, if during a first time period a company receives $100,000 in weekly revenue, but during a second time period the company receives $101,000 after revealing a new advertisement, it can be inferred that the new advertisement is responsible for $1,000 in incremental revenue (under the assumption that factors such as seasonality and competition are negligible). Although it is unknown which particular individuals saw the advertisement, the number of impressions for the new advertisement is available and known (e.g., based on how many times a website displayed the advertisement, etc.). Based on the number of impressions for the advertisement and the incremental revenue generated by the advertisement, a value for the advertisement can be determined. For example, if the incremental impressions 610 (i.e., the volume of impressions per period of time or incremental change in impressions) for the advertisement in this example is 200,000 impressions per week, and the incremental conversion value 620 (i.e., the incremental revenue generated by the advertisement withholding external factors or incremental change in business value) is $1,000 (640), then the new advertisement can be valued at $1,000 per 200,000 impressions 630, or $0.005 per impression. This value per impression is a baseline measurement for the value of the particular advertisement in influencing a particular keyword. This VPI can then be multiplied by a factor of one thousand to obtain a value per thousand impressions (“VPM”) 600 of $5 per thousand impressions, which conforms to advertisement buying practices (i.e., buying ads in a bulk number of impressions).

Therefore, the VPM 600 (as well as the VPI) is a measure of how valuable a particular advertisement's impressions are in driving the incremental (i.e., amount of revenue per period of time) performance for one or more entry points (e.g., search keywords). The VPI for any given advertisement is low, since it refers literally to the value of a single advertisement impression as it influences the performance of a particular entry point (e.g., a particular keyword). By determining each individual advertisement's VPI and/or VPM, an advertiser has actionable information that can be used to bid and buy more advertising opportunities according to the ad's calculated cross-channel value. In particular, the VPI and/or VPM can be displayed to a user (e.g., through a graphical user interface provided by the system 200 (e.g., through the webserver 260)) where the user can view the values and make decisions regarding advertising (e.g., change pricing or biding amounts for particular advertisements, change keywords associated with particular advertisements, etc.). In some embodiments, the interfaces provided by the system 200 displaying advertisement values can also display hypothetical scenarios based on the values (e.g., what would be a likely increase in revenue if the number of impressions was increased and what would be the corresponding cost for the increase in impressions). Accordingly, a user can use the interface and the information presented therein to better manage advertising goals and parameters.

Because the system 200 uses impression data of individual advertisements to determine the value of that advertisement, third-party tracking cookies are not required to be used by the system 200. Further, the system 200 does not require tracing purchase paths back to particular individuals who trigger a business event. Therefore, the issue of fragmentation in determining the cross-channel value of advertising is circumvented because impression data at the single advertisement level is complete (i.e., transcends the need to tag specific devices, browsers, and users to determine “who” has seen the advertisement).

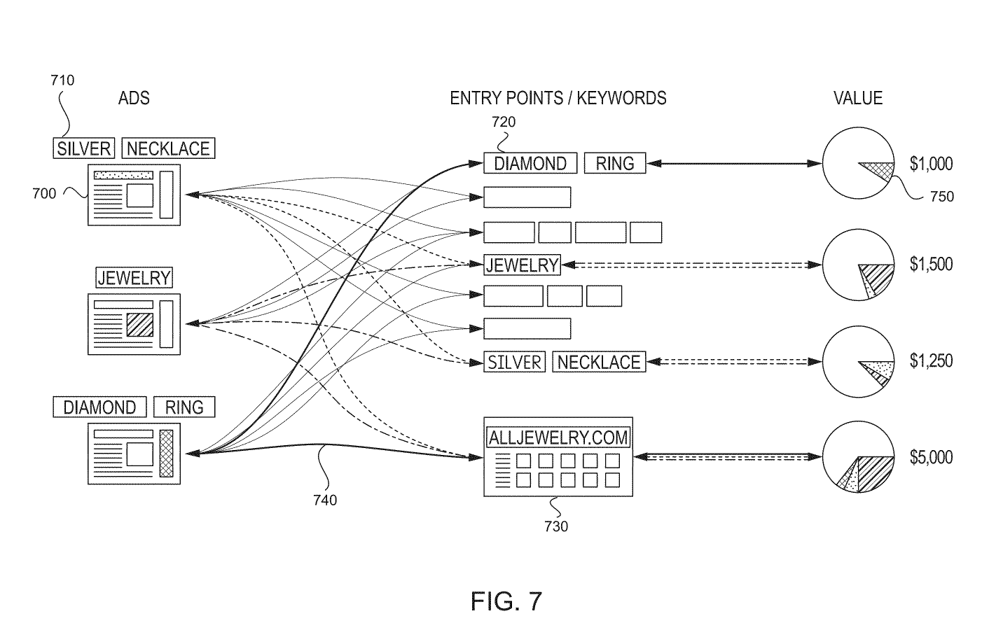

As previously mentioned, the system 200 assesses the cross-channel value of a particular advertisement at the individual advertisement and individual entry point level, since out 8 of many advertisement-to-entry-point relationships that can be analyzed, few are determined to have a performance-influencing relationship. Such performance-influencing relationships are detectable because observing advertisement-entry level relationships on a single-advertisement, single-keyword basis reduces the amount of noise contributing to the type of modeling required to identify meaningful advertisement-to-entry-point relationships. For example, FIG. 7 illustrates advertisement-to-entry-point relationships at the individual entry point level, using display advertisements and keywords as an example. As depicted by the dotted lines, every display advertisement 700 has features 710 that potentially affect particular keywords 720. These features can be evaluated for the advertisement-to-entry-point relationships. The display advertisement features 710 can include any feature of the display advertisement that would allow an individual to conduct a search in the search channel (i.e., access a buying channel) pertinent to that advertisement. In particular, the features 710 can be catchphrases, slogans, symbols, mascots, an identifier for a search channel, etc. Based on these features 710, an individual can search a keyword 720 in the search channel or access a business location 730, such as an advertiser's website, by clicking directly on the display advertisement. Although every display advertisement 700 has the potential to influence every keyword 720, in some situation, few advertisements 700 will actually affect the performance of certain keywords 720. The bolded lines indicate “meaningful” advertisement-to-keyword (i.e., advertisement-to-entry-point) relationships 740 (that can be generated via atomic-level, multivariate modeling), which means that the particular display advertisement 700 affects the particular keyword 720 by some quantifiable amount. This quantifiable amount can be reflected in an incremental revenue 750 attributed to the particular display advertisement 700.

As previously indicated, an econometric time series model with some additions can be used to analyze the advertisement-to-entry-point relationship (e.g., ad-to-keyword relationship in block 520 of FIG. 5) to determine the cross-channel effect of an advertisement. The additions overcome the challenges associated with econometric time series models and provides a practical implementation of the econometric time series model at a per advertisement level. Two challenges when using econometric time series models for advertising is over-fitting prevention and variable selection. The methods and processes described herein minimize these challenges.

Typically because very few observations exist relative to the number of available variables, traditional time series modeling algorithms that use an Auto Regressive Integrated Moving Average (ARIMA) are often susceptible to over-fitting. Over-fitting occurs when a trained model near perfectly describes past data, but is incapable of accurately forecasting future data. The challenges of over-fitting (overfitting) is minimized using at least one of three different techniques (mechanisms) or the combination of these three different techniques. First, a threshold is set on a minimum number of days (e.g., observations) for an ad to be eligible for model training and a minimum number of days for an ad's impressions to be eligible as an input variable. The threshold ensures that a sufficient number of observations (e.g., orders or impressions) are made to provide useful data that can be used for forecasting. Second, a regularized regression algorithm is used for the ARIMA, to reduce the probability of over-fitting during model training Regularization introduces additional information in the regression algorithm, which can reduce the number of variables, in order to minimize or prevent over-fitting. Third and finally, a Normalized Root Mean Squared Error (NRMSE) of training data is compared to the NRMSE of a holdout set. When the agreement between the two NRMSEs exceeds a specified threshold (or within a specified range of agreement), the model is then deployed for forecasting. The holdout set includes actual data that was not originally used in model training, which is used to verify the accuracy of the model. If the agreement of the NRMSE of the training data and the NRMSE of the holdout set is less than the specified threshold (or outside a specified range of agreement), the training data continues to acquire and accumulate data until the NRMSE of the holdout set or the NRMSE of a new holdset is in agreement with NRMSE of the training data within the specified threshold.

Variable selection (i.e., feature selection, attribute selection, or variable subset selection) is another challenge associated with econometric time series models for advertising. Variable selection is a process of selecting a subset of relevant variables or features for use in model construction or model training. Variable selection is based on a central assumption that the data contains many redundant or irrelevant variable (features). Redundant variables are those variables which provide no more information than the currently selected variables, and irrelevant variables provide no useful information in any context. Variable selection can be a challenge because many variables are correlated with each other. In some cases, one variable (e.g., television ratings) is the cause of variance in another variable (e.g., website traffic). Two techniques to address variable selection can be used increase the probability that the true causal variables are included in the models. First, empirical Bayesian ordering is imposed by assigning variables to phases of the training based on domain knowledge. For example, variables that are known to be causal related are designated for a first training phase. Empirical Bayesian ordering uses a Bayesian inference, in which Bayes' rule is used to update a probability estimate for a hypothesis as additional evidence or observations are acquired.

Second, a forward selection regression algorithm is then used that selects the next “best” variable for the model using the residual error from the model trained with the previously selected variables. This empirical Bayesian ordering “tilts the playing field” (i.e., influences variable selection) towards the known causal variables, giving variables with greater causal relationships the first chances to be selected. The forward selection regression is a type of stepwise regression. Stepwise regression includes regression models in which the choice of predictive variables is carried out by an automatic procedure. Forward selection (or feed-forward variable selection), which involves starting with no variables in the model, testing the addition of each variable using a chosen model comparison criterion, adding the variable (if any) that improves the model the most, and repeating this process until no additional variable improves the model.

As a result, the combination of a regularized regression, feed-forward variable selection, and empirical Bayesian ordering along with the thresholds on the number of training observations and NRMSE agreement allow an econometric time series model to be used in actual practical applications of determining cross-channel value of media advertising.

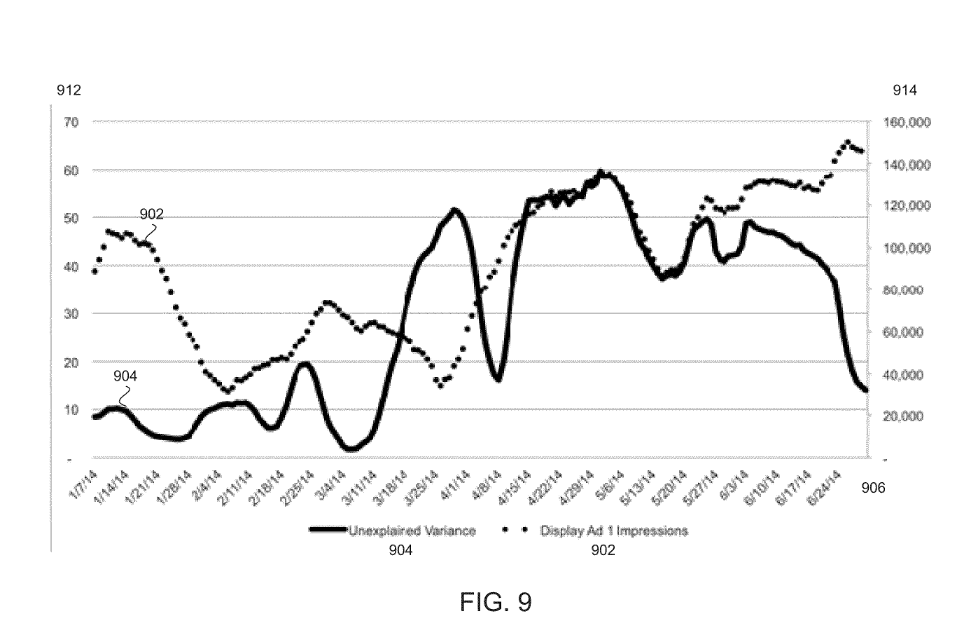

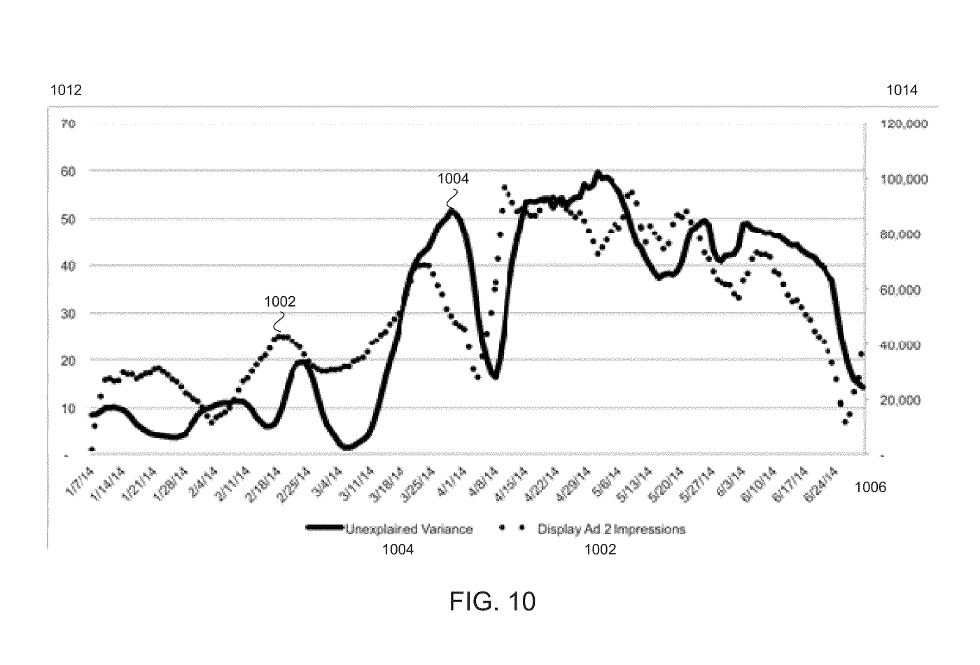

FIGS. 8-10 illustrate an example making a determination of advertisement-to-entry-point relationships using an econometric time series. FIG. 8 illustrates the result of a regularized regression algorithm to minimize over-fitting. FIGS. 9-10 illustrate a comparison used in variable selection between the impressions of an advertisement and the remaining variance (i.e., unassigned or unexplained variance) generated from the econometric time series, which may also include impression data from various advertisements.

In the example, an econometric time series is being used to determine the cross-channel effect of an ad. FIG. 8 shows the volume 802 of daily orders 804 of a paid search keyword over a date range 806. The model attempts to explain the day to day variance in orders based on the strength of correlation using the available variables. For example, variables like day of week (DOW) are very strong and are typically selected first, which results in orders with DOW variance removed 810. Variables for the day of month, month of year, and the position and price of the keyword are selected next since these direct effect variables are also correlated with the variance, which results in orders with the DOW and direct effects variance removed 812. Typically a minimum number of orders are also observed every day called the baseline orders that are subtracted from the orders, leaving orders with the DOW and direct effects variance removed along with the baseline orders removed 814 as the unexplained variance. The baseline orders can represent current orders not attributed to any current advertising campaign (e.g., general branding or reputation from past advertising).

Then, daily audience (i.e., number of impressions) from any candidate advertisement can be compared to the remaining order variance see if any correlation exists with the candidate advertisement. FIG. 9 shows the comparison of the impressions from a display advertisement (i.e., display ad 1 impressions) 902 against the remaining variance (unexplained variance) 904 over the date range 906. The left vertical axis represents the variance 912 and the right vertical axis represents the number of impressions 914. FIG. 9 illustrates that the display advertisement (i.e., display ad 1) does not correlated well to the remaining variance (i.e., display ad 1 is not a good fit), so this advertisement is rejected as a variable for the model (e.g., No after block 530 of FIG. 5).

FIG. 10 shows the comparison of the impressions from a second display advertisement (i.e., display ad 2 impressions) 1002 against the remaining variance (unexplained variance) 1004 over the date range 1006. The left vertical axis represents the variance 1012 and the right vertical axis represents the number of impressions 1014. FIG. 10 illustrates that the second display advertisement (i.e., display ad 2) does correlated well to the remaining variance (i.e., display ad 2 is a good fit), so this second advertisement is added as a variable to the model (e.g., Yes after block 530 of FIG. 5). In addition, the orders (e.g., business value) associated with the variance are assigned to the display advertisement, which removes this variance from the remaining variance. The process of comparing the impression data from each display advertisement to the remaining variance continues until the remaining order variance cannot be explained by the audience variance of any advertisement. Using this process, an econometric time series model can be used to analyze the advertisement-to-entry-point relationship in determining the cross-channel effect of a specific advertisement in an advertising campaign.

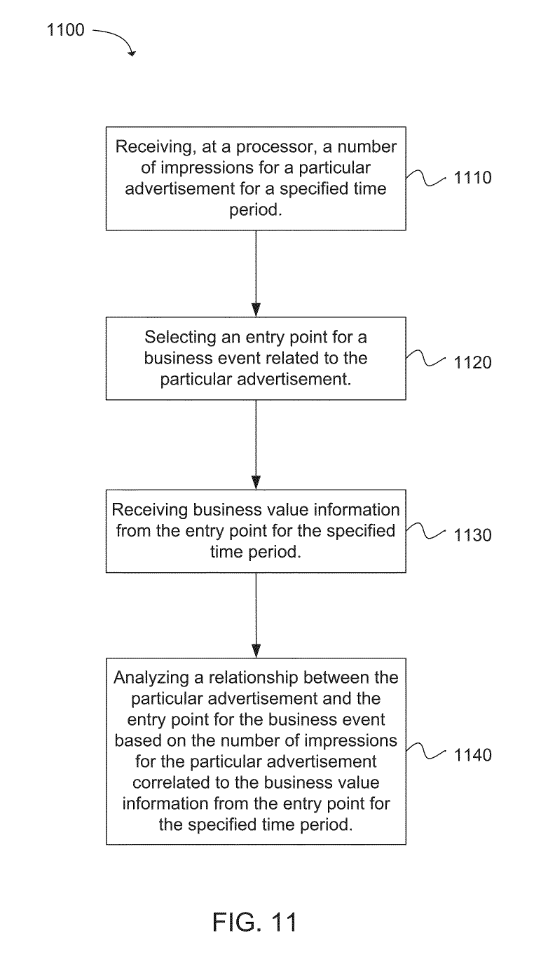

Another exemplary method, method 1100, is illustrated in FIG. 11. The method 1100 includes a computer-implemented process for assessing a cross-channel value of media advertising. The method 1100 may be carried out by, for example, the system 200 described above. The method begins by receiving, at a processor, a number of impressions for a particular advertisement for a specified time period, as in block 1110. The second step includes selecting an entry point for a business event related to the particular advertisement, as in block 1120. The next step includes receiving business value information from the entry point for the specified time period, as in 1130. Another step includes analyzing a relationship between the particular advertisement and the entry point for the business event based on the number of impressions for the particular advertisement correlated to the business value information from the entry point for the specified time period, as in block 1140.

Thus, embodiments of the invention relate to systems and methods for assessing the value of cross-channel advertising. It should be understood that the methods described can be carried out for any combination of cross-channel advertising, and are not strictly limited to the display and search channel combinations disclosed herein. Further, various system constructions or configurations can be used to implement the methods disclosed herein, and are not strictly limited to those described in the preceding exemplary embodiments.

What is claimed is:

1. A computer-implemented method for assessing a cross-channel value of media advertising, the method comprising:
receiving, at a processor, a number of impressions for a particular advertisement for a specified time period;
selecting an entry point for a business event related to the particular advertisement;
receiving business value information from the entry point for the specified time period;
analyzing a relationship between the particular advertisement and the entry point for the business event based on the number of impressions for the particular advertisement correlated to the business value information from the entry point for the specified time period.

2. The method of claim 1, wherein receiving business value information includes further comprises receiving value for a product or service related to the particular advertisement during the specified time period across multiple devices and multiple browsers, and wherein the impressions for the particular advertisement is displayed in an advertising channel selected from the group consisting of a display advertising channel, a branding channel, and a search advertising channel.

3. The method of claim 1, wherein when the relationship between the particular advertisement and the entry point for the business event exists, the method further comprises:
determining a magnitude of the relationship between the particular advertisement and the entry point based on the number of impressions for the particular advertisement and the business value from the entry point for the specified time period.

4. The method of claim 1, wherein when the relationship between the particular advertisement and the entry point for the business event exists, the method further comprises:
determining an incremental change in impressions for the particular advertisement over the specified time period;
determining an incremental change in business value from the entry point for the specified time period; and
calculating a value per impression from the incremental change in business value divided by the incremental change in impressions for the particular advertisement over the specified time period.

5. The method of claim 1, further comprising:
determining the number of impressions for the particular advertisement for the specified time period based on information from a webserver; and
determining the business value information from the entry point for the specified time period based on revenue data from business accounting systems.

6. The method of claim 1, further comprising:
evaluating the particular advertisement for at least one feature associated with the entry point, wherein the feature is selected from the group consisting of a catchphrase, a slogan, a symbol, a mascot, and an identifier for a search channel, wherein the feature is used to determine the relationship between the particular advertisement and the entry point for the business event.

7. The method of claim 1, wherein receiving business value information further comprises receiving value for a product or service related to the particular advertisement during the specified time period.

8. The method of claim 1, wherein the entry point is buying channel through which a consumer can make a purchase.

9. The method of claim 1, wherein the entry point is a mechanism by which an individual can perform a business event, wherein the business event is selected from the group consisting of a conversion, an order, a sale, a lead, an application, and a registration; and wherein the business value is selected from the group consisting of revenue, margin, or profit.

10. The method of claim 1, wherein analyzing a relationship between the particular advertisement and the entry point for the business event further comprises:
evaluating textual features and non-textual features of the particular advertisement related to the features of the entry point.

11. An audience-based system for assessing the cross-channel value of media advertising, the system comprising:
a memory storing data, the data comprising:
a number of impressions for a particular advertisement for a specified time period,
entry points for a business event related to the particular advertisement,
business value information from the entry point for the specified time period, and
an advertisement-to-entry-point relationship model that determines whether the particular advertisement influences the entry point for the business event; and
at least one processor for:
selecting an entry point for a business event related to the particular advertisement, and
determining, via the advertisement-to-entry-point relationship model, whether the particular advertisement influences the entry point for the business event based on the number of impressions for the particular advertisement and the business value from the entry point for the specified time period.

12. The system of claim 11, wherein the advertisement-to-entry-point relationship model includes a econometric time series forecast model that includes over-fitting minimization and variable selection; wherein over-fitting minimization includes an over-fitting mechanism selected from the group consisting of setting a threshold minimum number of days for model training of advertisement, setting a threshold minimum number of advertisement impressions for the model training, using a regularized regression algorithm, and comparing a normalized root mean squared error (NRMSE) of training data to a NRMSE of a holdout set of data; and wherein variable selection includes a variable selection mechanism selected from the group consisting of assigning variables using empirical Bayesian ordering and correlating variables using a forward selection regression algorithm.

13. The system of claim 11, wherein the entry point is a mechanism by which an individual can perform a business event; wherein the business event is selected from the group consisting of a conversion, an order, a sale, a lead, an application, and a registration; and wherein the business value is selected from the group consisting of revenue, margin, or profit.

14. The system of claim 11, wherein the entry point is selected from a group consisting of a result of a keyword or key phrase related to the particular advertisement, a uniform resource locator of a website, and a link from a website; and wherein the number of impressions is a number of times the particular advertisement is displayed.

15. The system of claim 11, wherein at least one processor is further configured to determine a number of searches associated with particular advertisement that lead to the business event.

16. Non-transitory computer-readable medium encoded with a plurality of processor-executable instructions for:
receiving, at a processor, a number of impressions for a particular advertisement for a specified time period;
selecting an entry point for a business event related to the particular advertisement;
receiving business value information from the entry point for the specified time period;
determining, by mathematical modeling, whether the particular advertisement influences the entry point for the business event based on the number of impressions for the particular advertisement and the business value from the entry point for the specified time period.

17. The computer-readable medium of claim 16, wherein when the particular advertisement influences the entry point, the plurality of processor-executable instructions is further configured for determining a magnitude of a relationship between the particular advertisement and the entry point based on the number of impressions for the particular advertisement and the business value from the entry point for the specified time period.

18. The computer-readable medium of claim 16, wherein when the particular advertisement influences the entry point, the plurality of processor-executable instructions is further configured for generating a value per impression from an incremental change in business value divided by an incremental change in impressions for the particular advertisement over the specified time period.

19. The computer-readable medium of claim 16, wherein the entry point is a mechanism by which an individual can perform a business event; wherein the business event is selected from the group consisting of a conversion, an order, a sale, a lead, an application, and a registration; and the business value is selected from the group consisting of revenue, margin, or profit.

20. The computer-readable medium of claim 16, wherein the entry point is selected from a group consisting of a result of a keyword or key phrase related to the particular advertisement, a uniform resource locator of a website, and a link from a website; and wherein the number of impressions is a number of times the particular advertisement is displayed.

21. The computer-readable medium of claim 16, wherein the mathematical modeling includes an econometric time series forecast model.

22. The computer-readable medium of claim 16, wherein the plurality of processor-executable instructions further comprises:
evaluating the particular advertisement for at least one feature associated with the entry point, wherein the feature is selected from the group consisting of a catchphrase, a slogan, a symbol, a mascot, and an identifier for a search channel, wherein the feature is used to determine whether the particular advertisement influences the entry point for the business event.
